(19) United States
(12) Patent Application Publication
(10) Pub. No.: US 2025/0319438 A1
(43) Pub. Date: Oct. 16, 2025

(54) LIDAR SYSTEM AND INVERSION METHOD FOR SIMULTANEOUSLY DETECTING CARBON SEQUESTRATION EFFICIENCY OF OCEANIC BIOLOGICAL PUMP AND OCEAN ENVIRONMENTAL DYNAMIC PARAMETERS

(71) Applicant: SOUTHERN MARINE SCIENCE AND ENGINEERING GUANGDONG LABORATORY(GUANGZHOU), Guangzhou (CN)

(72) Inventors: Dapeng YUAN, Guangzhou (CN); Delu PAN, Guangzhou (CN)

(21) Appl. No.: 18/792,603

(22) Filed: Aug. 2, 2024

(30) Foreign Application Priority Data
Apr. 12, 2024 (CN) 202410438768.0

(51) Int. Cl. B01D 53/84; B01D 53/34; B01D 53/62; G01S 7/481; G01S 7/4863; G01S 17/89

(52) U.S. Cl. CPC B01D 53/84; B01D 53/346; B01D 53/62; G01S 7/4814; G01S 7/4816; G01S 7/4863; G01S 17/89

(57) ABSTRACT

A lidar system and an inversion method for simultaneously detecting carbon sequestration efficiency of the oceanic biological pump and ocean environmental dynamic parameters. The information of Mie scattering and Brillouin scattering intensity and the information of frequency shift and linewidth of Brillouin scattering spectra are combined, and for the detection requirements of the current ocean carbon cycle and dynamic environmental parameters, the vertical profile distribution of the carbon cycle mechanism and environmental dynamic parameters in the euphotic layer is mainly detected; at the same time, the present disclosure constructs an inversion model of the carbon sequestration efficiency of the oceanic biological pump and the temperature and salinity of the environmental dynamic parameters and realizes the synchronous detection of the carbon sequestration efficiency of the oceanic biological pump and the vertical profile distribution of the ocean environmental dynamic parameters in the euphotic layer.

### CROSS-REFERENCE TO RELATED APPLICATIONS

The present application claims priority to Chinese Patent Application No. 202410438768.0, filed on Apr. 12, 2024, the content of which is incorporated herein by reference in its entirety.

### TECHNICAL FIELD

The present disclosure relates to the field of ocean optical detection, and in particular, to a lidar system and an inversion method for simultaneously detecting carbon sequestration efficiency of the oceanic biological pump and ocean environmental dynamic parameters.

### BACKGROUND

An oceanic biological pump is a process in which the photosynthesis of ocean phytoplankton produces Particulate Organic Carbon (POC) and the POC is transferred from the upper water body to the deep water body and even to the seabed through a series of biological processes such as feeding by zooplankton and settling of particulate matter, and it plays a key role in regulating the concentration of CO₂ in the atmosphere and ocean carbon cycle. At the same time, Ocean Primary Productivity (OPP) and POC output flux can directly characterize the photosynthetic rate of ocean phytoplankton and the operating capacity of the oceanic biological carbon pump, and the ratio of the POC output flux to the OPP can measure the carbon sequestration efficiency of the oceanic biological pump. Therefore, it is of great significance to evaluate the carbon sequestration efficiency of the oceanic biological pump for global climate change and the ocean carbon cycle. On the other hand, the temperature and salinity of seawater are the main dynamic environmental parameters of water, and its vertical profile structure determines the distribution of nutrients and phytoplankton. At the same time, ocean dynamic environmental processes (such as vortex, thermocline, upwelling, etc.) are closely related to marine biological resources. Therefore, it is of great significance to detect the vertical profile of the carbon sequestration efficiency of the oceanic biological pump and obtain the vertical profile distribution of water dynamic environmental parameters (temperature, salinity, etc.) for the study of ocean ecological environmental dynamics and the sustainable utilization of marine living resources. At present, the existing lidar technology cannot simultaneously obtain the carbon sequestration efficiency of the oceanic biological pump and the vertical profile distribution of ocean environmental dynamic parameters. Therefore, it is urgent to develop a new ocean lidar detection technology to realize synchronous detection of carbon sequestration efficiency of the biological pump and vertical profile distribution of ocean environmental dynamic parameters in the euphotic layer.

### SUMMARY

In view of the shortcomings of the prior art, the present disclosure discloses a lidar system and an inversion method for simultaneously detecting the carbon sequestration efficiency of the oceanic biological pump and ocean environmental dynamic parameters. The system combines Mie scattering, Brillouin scattering intensity information, and Brillouin scattering spectra (frequency shift and linewidth) information, and focuses on detecting the carbon sequestration efficiency of the oceanic biological pump and the vertical profile distribution of ocean environmental dynamic parameters in the euphotic layer for the detection requirements of the current ocean carbon cycle and environmental dynamic parameters.

The object of the present disclosure is achieved through the following technical solutions:

A lidar system for simultaneously detecting the carbon sequestration efficiency of the oceanic biological pump and ocean environmental dynamic parameters includes a vertically polarized laser emitting subsystem, a first beam splitter, a first photodetector, a first reflecting mirror, a telescope, a second reflecting mirror, a bandpass filter, a second beam splitter, a third reflecting mirror, a second photodetector, a third beam splitter, a fourth reflecting mirror, a first Fabry-Perot interferometer, a third photodetector, a focusing lens, a pinhole filter, a beam expander, a second Fabry-Perot interferometer, an intensified charge-coupled device (ICCD) acquisition subsystem, an adaptive gain controller, a data acquisition card, a digital delay pulse generator and computer.

The vertically polarized laser emitting subsystem (1) emits a narrow linewidth laser pulse of 532 nm.

The first beam splitter and the first reflecting mirror form a first beam splitting unit, and the first beam splitter is configured to split the laser into two beams, One beam is received by the first photodetector, and the first photodetector monitors the stability of the power of the laser pulse emitted by the vertically polarized laser emitting subsystem in real-time, and other beam is incident into seawater after passing through the first reflecting mirror to generate a backscattered signal.

The telescope is configured to receive the backscattered signal generated by the laser pulse in the seawater.

The second reflecting mirror, the bandpass filter, the second beam splitter, and the third reflecting mirror form a second beam splitting unit, and the backscattered signal received by the telescope passes through the second reflecting mirror and the bandpass filter in turn and then is incident into the second beam splitter; the second beam splitter splits a laser beam into two beams, with one beam entering the second photodetector through the third reflecting mirror, and the other beam entering a third beam splitting unit consisting of the third beam splitter and the fourth reflecting mirror.

The third beam splitter splits the beam into two beams, one beam being received by the third photodetector after passing through the fourth reflecting mirror and the first Fabry-Perot interferometer in turn, and the other beam being incident into a collimating filter unit consisting of the focusing lens, the pinhole filter, and the beam expander; after the backscattered signal is focused by the focusing lens, the stray light in the backscattered signal is filtered out by the pinhole filter and then enters the ICCD acquisition subsystem through the beam expander.

The adaptive gain controller and the data acquisition card form a data acquisition unit. The adaptive gain controller is configured to control the gain coefficients of the first photodetector, the second photodetector, and the third photodetector; signals acquired by the first photodetector, the second photodetector, the third photodetector, and the ICCD acquisition subsystem are collected by the data acquisition card and then enter the computer, and the computer corrects and processes lidar data received by the data acquisition card in real time; the digital delay pulse generator is configured to control time delays of the vertically polarized laser emitting subsystem and the ICCD acquisition subsystem.

An inversion method for simultaneously detecting the carbon sequestration efficiency of the oceanic biological pump and ocean environmental dynamic parameters is realized based on the lidar system, and the inversion method includes:

S1: making a laser pulse with a wavelength of A emitted by the vertically polarized laser emitting subsystem incident into an ocean water body through a sea surface, dividing the backscattered signal generated in the ocean water body into a hybrid receiving channel, a

Brillouin scattering intensity information receiving channel and a Brillouin scattering frequency spectrum information receiving channel after being received by the telescope, preprocessing received Mie scattering intensity information, Brillouin scattering intensity information and Brillouin scattering frequency spectrum information, reserving the backscattered signal of the water body, and obtaining a backscattered signal Sₚ(λ, z) of water body particles, a water body Brillouin scattering intensity S_{b}(λ, z) at a z depth, and water body Brillouin scattering interference circles at different depths.

S2, calculating the carbon sequestration efficiency E_{poc} of the oceanic biological pump and vertical profile distribution of the environmental dynamic parameters along lidar tracks, respectively.

The present disclosure has the following beneficial effects:

Compared to the related art, according to the lidar system and the inversion method for simultaneously detecting the carbon sequestration efficiency of the oceanic biological pump and ocean environmental dynamic parameters, based on Mie scattering intensity information, Brillouin scattering intensity information and Brillouin scattering spectrum information, not only can acquire subsurface data on water bodies, but also achieve the synchronous detection of carbon sequestration efficiency of the oceanic biological pump and vertical profile of environmental dynamic parameters (temperature and salinity), thereby enabling comprehensive analysis of the vertical structure of marine ecosystems and carbon cycling processes, and facilitating advancements in research on ocean carbon cycling, ecosystem carbon sinks, ocean environmental dynamic processes (such as eddies, thermoclines, upwelling, etc.), and sustainable utilization of marine biological resources. By gaining deeper insights into biological and physical processes in the ocean, this technology can provide important support and reference for ecological conservation, resource management, and climate change studies.

### BRIEF DESCRIPTION OF DRAWINGS

FIG. 1 is a schematic diagram of a lidar system for simultaneously detecting the carbon sequestration efficiency of the oceanic biological pump and ocean environmental dynamic parameters according to an embodiment of the present disclosure.

In the figure: Vertically polarized laser emitting subsystem 1, First beam splitter 2, First photodetector 3, First reflecting mirror 4, Seawater 5, Telescope 6, Second reflecting mirror 7, Bandpass filter 8, Second beam splitter 9, Third reflecting mirror 10, Second photodetector 11, Third beam splitter 12, Fourth reflecting mirror 13, First Fabry-Perot interferometer 14, Third photodetector 15, Focusing lens 16, Pinhole filter 17, Beam expander 18, Second Fabry-Perot interferometer 19, ICCD acquisition subsystem 20, Adaptive gain controller 21, Data acquisition card 22, Digital delay pulse generator 23, and Computer 24;

FIG. 2 is a flow chart of the inversion method for simultaneously detecting the carbon sequestration efficiency of the oceanic biological pump and ocean environmental dynamic parameters in this embodiment.

FIG. 3 is the result of processing interference circles with different edge functions of the present disclosure.

FIG. 4 is an identification result of interference circles.

### DESCRIPTION OF EMBODIMENTS

The object and effect of the present disclosure will become more apparent when the present disclosure is described in detail according to the attached drawings and preferred embodiments. It should be understood that the specific embodiments described here are only for explaining the present disclosure and are not used to limit the present disclosure.

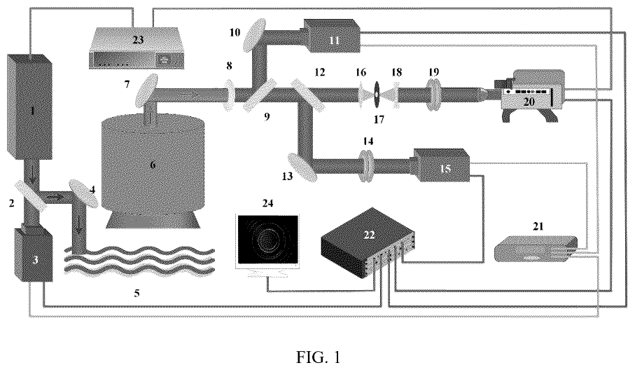

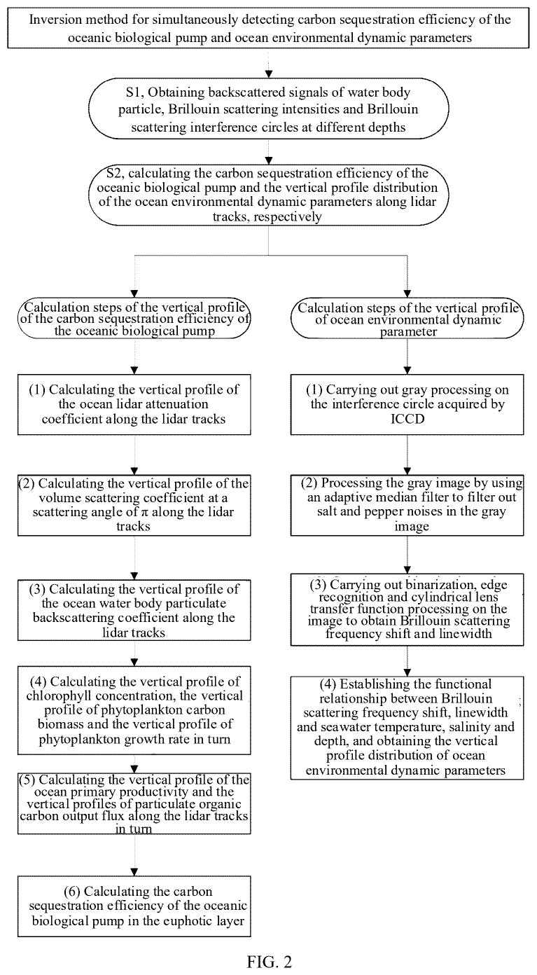

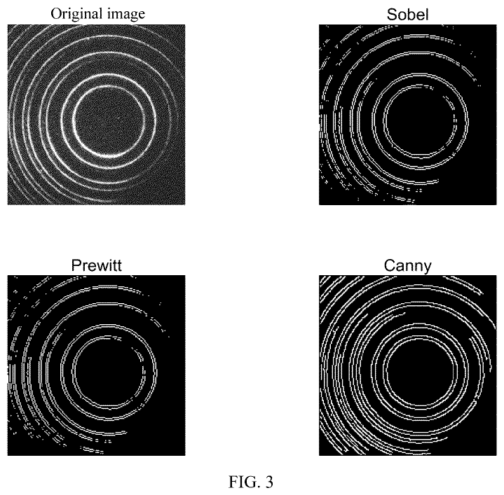

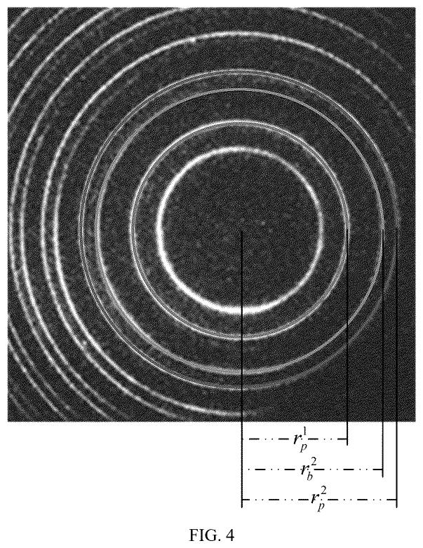

As shown in FIG. 1, a lidar system for detecting carbon sequestration efficiency of the oceanic biological pump and ocean environmental dynamic parameters of the present disclosure, includes a vertically polarized laser emitting subsystem 1, a first beam splitter 2, a first photodetector 3, a first reflecting mirror 4, a telescope 6, a second reflecting mirror 7, a bandpass filter 8, a second beam splitter 9, a third reflecting mirror 10, a second photodetector 11, a third beam splitter 12, a fourth reflecting mirror 13, a First Fabry-Perot interferometer 14, a third photodetector 15, a focusing lens 16, a pinhole filter 17, a beam expander 18, a Second Fabry-Perot interferometer 19, an ICCD acquisition subsystem 20, an adaptive gain controller 21, a data acquisition card 22, a digital delay pulse generator 23 and computer 24.

The vertically polarized laser emitting subsystem 1 emits a narrow linewidth laser pulse of 532 nm.

The first beam splitter 2 and the first reflecting mirror 4 form a first beam splitting unit, and the first beam splitter 2 is configured for splitting laser into two beams, one of which is received by the first photodetector 3, and the first photodetector 3 monitors the stability of power of the laser pulse emitted by the vertically polarized laser emitting subsystem 1 in real time; the other beam is incident into seawater 5 after passing through the first reflecting mirror 4 to generate a backscattered signal.

The telescope 6 is configured for receiving the backscattered signal generated by the laser pulse in seawater.

The bandpass filter 8 is used to filter out background noise and stray light in the lidar backscattered signal. After the bandpass filter 8 filters out the background noise and stray light, the laser beam enters the second beam splitting unit. In an embodiment, the central wavelength of the bandpass filter 8 is 532 nm, the transmittance is more than 90%, the short-wave cutoff range is 200-520 nm, and the long-wave cutoff range is 540-1200 nm.

The second reflecting mirror 7, the bandpass filter 8, the second beam splitter 9, and the third reflecting mirror 10 form a second beam splitting unit, and the backscattered signal received by the telescope 6 passes through the second reflecting mirror 7 and the bandpass filter 8 in turn and then is incident into the second beam splitter 9; the second beam splitter 9 splits a laser beam into two beams, with one beam entering the second photodetector 11 through the third reflecting mirror 10; the intensity information of Mie scattering and Brillouin scattering is received by the second photodetector, and the other beam enters the third beam splitting unit.

The third beam splitter 12 splits the beam into two beams, one beam being received for the intensity information of Brillouin scattering by the third photodetector 15 after passing through the fourth reflecting mirror 13 and the First Fabry-Perot interferometer 14 in turn, and the other beam being incident into a collimating filter unit.

The collimating filter unit consists of the focusing lens 16, the pinhole filter 17, and the beam expander 18; after being focused by the focusing lens 16, the backscattered signal enters the pinhole filter 17, and the stray light in the backscattered signal is filtered out by the pinhole filter 17, and then enters the ICCD acquisition subsystem 20 through the beam expander 18.

The adaptive gain controller 21 and the data acquisition card 22 form a data acquisition unit; the adaptive gain controller 21 is configured for controlling gain coefficients of the first photodetector 3, the second photodetector 11, and the third photodetector 15; signals acquired by the first photodetector 3, the second photodetector 11, the third photodetector 15 and the ICCD acquisition subsystem 20 are collected by the data acquisition card 22 and then enter the computer 24, and the computer 24 is used to correct and process lidar backscattered data received by the data acquisition card 22 in real-time.

The digital delay pulse generator 23 is configured for controlling time delays of the vertically polarized laser emitting subsystem 1 and the ICCD acquisition subsystem 20.

As shown in FIG. 2, the inversion method for simultaneously detecting carbon sequestration efficiency of the oceanic biological pump and ocean environmental dynamic parameters of the present disclosure specifically includes the following steps:

S1: the laser pulse with a wavelength of A emitted by the vertically polarized laser emitting subsystem 1 is incident into an ocean water body through a sea surface; the backscattered signal generated in the ocean water body is divided into a hybrid receiving channel, a Brillouin scattering intensity information receiving channel and a Brillouin scattering frequency spectrum information receiving channel after being received by the telescope 6, and the received Mie scattering intensity information, Brillouin scattering intensity information and Brillouin scattering frequency spectrum information are preprocessed, the backscattered signal of the water body is reserved, and a backscattered signal Sₚ(λ, z) of water body particles, a water body Brillouin scattering intensity S_{b}(λ, z) at a depth of z, and water body Brillouin scattering interference circles at different depths are obtained.

S2, the carbon sequestration efficiency E_{poc} of the oceanic biological pump and the vertical profile distribution of the ocean environmental dynamic parameters (temperature and salinity) along lidar tracks are calculated, respectively.

The calculation of the carbon sequestration efficiency of the oceanic biological pump along the lidar tracks in S2 includes the following sub-steps:

(1) An ocean water body lidar attenuation coefficient Kuidar (A, z) at the depth of z is calculated:

$$\begin{matrix}{S}_{b} ( λ , z ) = \frac{{C}_{b}}{{( nH + z )}^{2}} {β}_{b}^{π} ( λ , z ) exp [ - 2 {\int }_{0}^{z} {K}_{li dar} ( λ , {z}^{′} ) {dz}^{′} ] \\ {K}_{lidar} ( λ , z ) = - \frac{1}{2} \frac{d}{dz} ln [ {β}_{b}^{π} ( λ , z ) {( nH + z )}^{2} ]\end{matrix}$$

where S_{b}(λ, z) represents the Brillouin scattering intensity information of the water body at the depth of z, C_{b} represents a system constant of a Brillouin scattering intensity channel, n is the refractive index of the seawater, H represents the height of a lidar operation platform from the sea surface and

$${β}_{b}^{π} ( λ , z )$$

represents a Dinouin backscattering coefficient at the depth of z.

(2) A volume scattering coefficient

$${β}_{p}^{π} ( λ , z )$$

at a scattering angle or π is further calculated based on the ocean water body lidar attenuation coefficient K_{lidar}(λ, z) obtained from the Brillouin scattering intensity information:

$${S}_{p} ( λ , z ) = \frac{{C}_{p}}{{( nH + z )}^{2}} [ {β}_{p}^{π} ( λ , z ) + {β}_{b}^{π} ( λ , z ) ] exp [ - 2 {\int }_{0}^{z} {K}_{lidar} ( λ , {z}^{′} ) {dz}^{′} ]$$

where Sₚ(λ, z) represents an intensity of the backscattered signal received by the hybrid channel at the depth of z, Cₚ represents a system constant of the hybrid channel, and

$${β}_{b}^{π} ( λ , z )$$

represents a Brillouin backscattering coefficient at the depth of z.

(3) The ocean water body particulate backscattering coefficient

$${b}_{bp}^{lidar} ( λ , z )$$

along the lidar tracks at the depth of z is calculated:

$${b}_{bp}^{lidar} ( λ , z ) = 2 {πχβ}_{p}^{π} ( λ , z )$$

where χ represents a conversion factor between

$${β}_{p}^{π} ( λ , z ) {b}_{bp}^{lidar} ( λ , z ) .$$

(4) Based on the vertical profile of the particulate backscattering coefficient along the lidar tracks

$${b}_{bp}^{lidar} ( λ , z )$$

and the vertical profile of photosynthetically available radiation along the lidar tracks PAR_{lidar}(z), the vertical profile of chlorophyll concentration along the lidar tracks Chl_{lidar}(z), the vertical profile of phytoplankton carbon biomass along the lidar tracks

$${C}_{phy}^{lidar} ( z ) ,$$

and the vertical profile of phytoplankton growth rate along the lidar tracks μ_{lidar}(z) are calculated in turn.

(5) The vertical profile of ocean primary productivity along the lidar tracks OPP_{lidar}(z) is calculated based on the vertical profile of phytoplankton carbon biomass

$${C}_{phy}^{lidar} ( z )$$

and the vertical profile of the phytoplankton growth rate λ_{lidar}(z), and the ocean primary productivity OPP_{lidar}(z) can be accumulated along the depth of z to obtain the total ocean primary productivity OPPₜₒₜₐₗ in the euphotic layer:

$$\begin{matrix}{OPP}_{lidar} ( z ) = {C}_{phy}^{lidar} ( z ) \times {μ}_{lidar} ( z ) \\ {OPP}_{total} = {\sum }_{0}^{Z} {OPP}_{lidar} ( z )\end{matrix}$$

Based on the vertical profile of the particulate backscattering coefficient along the lidar tracks

$${b}_{bp}^{lidar} ( λ , z )$$

and the particulate organic carbon concentration data measured in the laboratory, a linear fitting model is established to calculate the vertical profile of particulate organic carbon along the lidar tracks POC_{lidar}(z); POC_{lidar}(z) is accumulated along the depth of z to obtain a particulate organic carbon stock

$${POC}_{stock}^{lidar}$$

in the euphotic layer; a particulate organic carbon output flux

$${POC}_{flux}^{lidar}$$

is calculated based on the particulate organic carbon stock

$${POC}_{stock}^{lidar}$$

in the euphotic layer.

$$\begin{matrix}{POC}_{lidar} ( z ) = a 1 \times {b}_{bp}^{lidar} ( λ , z ) + a 2 \\ {POC}_{stock}^{lidar} = {\sum }_{0}^{z} {POC}_{lidar} ( z ) \\ {POC}_{flux}^{lidar} = b 1 \times {POC}_{stock}^{lidar} - b 2\end{matrix}$$

where a1 and a2 are both fitting coefficients of the water body particulate backscattering coefficient

$${b}_{bp}^{lidar} ( λ , z )$$

and the particulate organic carbon concentration; b1 and b2 are both fitting coefficients between the particulate organic carbon stock

$${POC}_{stock}^{lidar}$$

and the particulate organic carbon output flux

$${POC}_{flux}^{lidar} .$$

(6) The carbon sequestration efficiency of the oceanic biological pump E_{BCP} in the euphotic layer is calculated based on the particulate organic carbon output flux

$${POC}_{flux}^{lidar}$$

in the euphotic layer and the ocean primary productivity OPPₜₒₜₐₗ in the euphotic layer:

$${E}_{BCP} = \frac{{POC}_{flux}^{lidar}}{{OPP}_{total}} .$$

The step of calculating the vertical profile of ocean environmental dynamic parameters (temperature, salinity) along the lidar tracks includes the following sub-steps:

(1) Gray processing is performed on the interference circle S_{circle} collected by the ICCD acquisition subsystem to obtain a gray image

$${S}_{circle}^{gray} .$$

(2) The adaptive median filter is used to process the gray image

$${S}_{circle}^{gray} ,$$

and the salt and pepper noise in the gray image

$${S}_{circle}^{gray}$$

is filtered to obtain the image

$${S}_{circle}^{AMF} .$$

(3) A binary function processing is carried out on the image

$${S}_{circle}^{AMF}$$

processed by the adaptive median filter to determine the optimal binarization threshold and obtain a binarized image

$${S}_{circle}^{bw} ;$$

an edge processing is carried out on the binarized image

$${S}_{circle}^{bw} ,$$

and the images processed by edge functions such as a Roberts operator, a Sobel operator, a Prewitt operator, a Kirsch operator, a Robinson operator, a Laplacian operator, a Canny operator, and a Gaussian Laplacian operator, to obtain the optimal edge function processed image

$${S}_{circle}^{edge} ;$$

the image processed by the Sobel operator, Prewitt operator, and Canny operator in this embodiment is shown in FIG. 3; then, the adaptive threshold processing function is used to obtain the optimal threshold parameter of the edge algorithm, and the circle identification is carried out on the image

$${S}_{circle}^{edge}$$

to obtain a first-order elastic scattering circle radius

$${r}_{p}^{1} ,$$

a second-order Brillouin scattering the circle radius

$${r}_{b}^{2}$$

and a second-order elastic scattering circle radius

$${r}_{p}^{2} ,$$

respectively, as shown in FIG. 4. Finally, the Brillouin frequency shift Δv_{b} can be obtained by using the identified concentric scattering circle radius and the free spectral range FSR of the Fabry-Perot interferometer:

$$Δ {v}_{b} = \frac{{( {r}_{p}^{2} )}^{2} - {( {r}_{b}^{2} )}^{2}}{{( {r}_{p}^{1} )}^{2} - {( {r}_{b}^{2} )}^{2}} FSR$$

Because the ICCD acquisition subsystem is highly sensitive to the backscattered signal intensity, and the cylindrical lens has the function of beam convergence, to reduce the damage risk of the backscattered signal intensity to the photosensitive unit of the ICCD acquisition subsystem, the image

$${S}_{circle}^{AMF}$$

processed by the adaptive median filter is simulated by using the beam transmission function of the cylindrical lens, and the point-like spectrum intensity distribution

$${S}_{circle}^{CLSF} ,$$

of different interference circles is obtained, and the Brillouin scattering linewidth Γ_{b} is obtained:

$${Γ}_{b} = \frac{{( {r}_{1} + {Γ}_{b}^{1} / 2 )}^{2} - {( {r}_{1} - {Γ}_{b}^{1} / 2 )}^{2}}{{( {r}_{1} + a )}^{2} - {r}_{1}^{2}} FSR$$

where r₁ represents the geometric radius of the center of the first spot of the image

$${S}_{circle}^{CLSF} ,$$

Γ_{b}¹ represents the full width at half maximum of the first spot of the image

$${S}_{circle}^{CLSF} ,$$

and a represents the distance between the center of the second spot and the center of the first spot.

(4) Steps (1) to (3) are repeated to calculate a Brillouin scattering frequency shift Δv_{b}(S, T, Z) and a linewidth Γ_{b}(S,T,Z) when salinity is S and seawater temperature is T at depth Z, the functional relationship between seawater temperature T, salinity S, and depth Z and Brillouin scattering frequency shift and linewidth is established, and the vertical profile distribution of ocean environmental dynamic parameters along the lidar tracks is obtained:

$$\{ \begin{matrix}Δ {v}_{b} ( S , T , Z ) = \pm \frac{2 n ( S , T , Z )}{λ} {V}_{s} ( S , T , Z ) \\ {Γ}_{b} ( S , T , Z ) = \frac{4 {π}^{2} Δ {{v}_{b} ( S , T , Z )}^{2} ( 3 {η}_{b} + 4 {η}_{s} )}{3 ρ ( S , T , Z ) {{V}_{s} ( S , T , Z )}^{2}}\end{matrix}$$

where n(S,T, Z) represents the refractive index of seawater at the depth Z with a salinity of S and a seawater temperature of T, Vₛ(S,T,Z) represents the sound velocity of seawater at the depth Z with a salinity of S and a seawater temperature of T, η_{b} represents a bulk viscosity coefficient, ηₛ represents a shear viscosity coefficient and ρ(S,T, Z) represents the seawater density at the depth Z with a salinity of S and a seawater temperature of T

What is claimed is:

1. A lidar system for simultaneously detecting carbon sequestration efficiency of the oceanic biological pump and ocean environmental dynamic parameters, wherein the lidar system comprises a vertically polarized laser emitting subsystem, a first beam splitter, a first photodetector, a first reflecting mirror, a telescope, a second reflecting mirror, a bandpass filter, a second beam splitter, a third reflecting mirror, a second photodetector, a third beam splitter, a fourth reflecting mirror, a First Fabry-Perot interferometer, a third photodetector, a focusing lens, a pinhole filter, a beam expander, a Second Fabry-Perot interferometer, an intensified charge-coupled device (ICCD) acquisition subsystem, an adaptive gain controller, a data acquisition card, a digital delay pulse generator and computer;
wherein the vertically polarized laser emitting subsystem emits a narrow linewidth laser pulse of 532 nm;
wherein the first beam splitter and the first reflecting mirror form a first beam splitting unit, and the first beam splitter is configured to split a laser into two beams, wherein one beam is received by the first photodetector, and the first photodetector monitors the stability of a power of a laser pulse emitted by the vertically polarized laser emitting subsystem in real time; and the other beam is incident into seawater after passing through the first reflecting mirror to generate a backscattered signal;
wherein the telescope is configured to receive the backscattered signal generated by the laser pulse in the seawater;
wherein the second reflecting mirror, the bandpass filter, the second beam splitter, and the third reflecting mirror form a second beam splitting unit, and the backscattered signal received by the telescope passes through the second reflecting mirror and the bandpass filter in turn and then is incident into the second beam splitter, the second beam splitter splits a laser beam into two beams, with one beam entering the second photodetector through the third reflecting mirror, and other beam entering a third beam splitting unit comprising the third beam splitter and the fourth reflecting mirror;
wherein the third beam splitter splits the laser beam into two beams, wherein one beam is received by the third photodetector after passing through the fourth reflecting mirror and the First Fabry-Perot interferometer in turn, and the other beam is incident into a collimating filter unit comprising the focusing lens, the pinhole filter, and the beam expander; and after the backscattered signal is focused by the focusing lens, stray light in the backscattered signal is filtered out by the pinhole filter and then enters the ICCD acquisition subsystem through the beam expander; and
wherein the adaptive gain controller and the data acquisition card form a data acquisition unit, wherein the adaptive gain controller is configured to control gain coefficients of the first photodetector, the second photodetector, and the third photodetector; signals acquired by the first photodetector, the second photodetector, the third photodetector, and the ICCD acquisition subsystem are collected by the data acquisition card and then enter the computer, and the computer corrects and processes lidar backscattered data received by the data acquisition card in real-time; and the digital delay pulse generator is configured to control time delays of the vertically polarized laser emitting subsystem and the ICCD acquisition subsystem.

2. The lidar system according to claim 1, wherein the bandpass filter has a central wavelength of 532 nm, a transmittance of more than 90%, a short-wave cut-off range of 200 nm-520 nm, and a long-wave cut-off range of 540 nm-1200 nm.

3. An inversion method for simultaneously detecting carbon sequestration efficiency of the oceanic biological pump and ocean environmental dynamic parameters, wherein the inversion method is realized based on the lidar system according to claim 1, and the inversion method comprises the following steps:
step S1: making a laser pulse with a wavelength of/emitted by the vertically polarized laser emitting subsystem incident into an ocean water body through a sea surface, dividing the backscattered signal generated in the ocean water body into a hybrid receiving channel, a Brillouin scattering intensity information receiving channel and a Brillouin scattering frequency spectrum information receiving channel after being received by the telescope, preprocessing received Mie scattering intensity information, Brillouin scattering intensity information and Brillouin scattering frequency spectrum information, reserving the backscattered signal of the water body, and obtaining a backscattered signal Sₚ(λ, z) of water body particles, a water body Brillouin scattering intensity S_{b}(λ, z) at a z depth, and water body Brillouin scattering interference circles at different depths; and
step S2, calculating the carbon sequestration efficiency E_{poc} of the oceanic biological pump and the vertical profile distribution of the ocean environmental dynamic parameters along lidar tracks, respectively.

4. The inversion method according to claim 3, wherein calculating the carbon sequestration efficiency E_{poc} of the oceanic biological pump along lidar tracks in step S2 comprises the following sub-steps:
sub-step 1.1, calculating an ocean water body lidar attenuation coefficient K_{lidar}(λ, z) at the z depth by the following formula:
$${S}_{b} ( λ , z ) = \frac{{C}_{b}}{{( nH + z )}^{2}} {β}_{b}^{π} ( λ , z ) exp [ - 2 {\int }_{0}^{z} {K}_{lidar} ( λ , {z}^{′} ) {dz}^{′} ] ,$$
$${K}_{lidar} ( λ , z ) = - \frac{1}{2} \frac{d}{dz} ln [ {β}_{b}^{π} ( λ , z ) {( nH + z )}^{2} ] ,$$
where S_{b}(λ, z) represents the Brillouin scattering intensity information of the water body at the z depth, C_{b} represents a system constant of a Brillouin scattering intensity channel, n represents a refractive index of the seawater, H represents the height of a lidar operation platform from the sea surface, and
$${β}_{b}^{π} ( λ , z )$$
represents a Brillouin backscattering coefficient at the z depth;
sub-step 1.2, calculating a volume scattering coefficient
$${β}_{p}^{π} ( λ , z )$$
at a scattering angle of π by the following formula:
$${S}_{p} ( λ , z ) = \frac{{C}_{p}}{{( nH + z )}^{2}} [ {β}_{p}^{π} ( λ , z ) + {β}_{b}^{π} ( λ , z ) ] exp [ - 2 {\int }_{0}^{z} {K}_{lidar} ( λ , {z}^{′} ) {dz}^{′} ] ,$$
where Sₚ(λ, z) represents an intensity of the backscattered signal received by a hybrid channel at the z depth, Cₚ represents a system constant of the hybrid channel, and
$${β}_{b}^{π} ( λ , z )$$
represents a Brillouin backscattering coefficient at the z depth;
sub-step 1.3, calculating the ocean water body particulate backscattering coefficient
$${b}_{bp}^{lidar} ( λ , z )$$
along the lidar tracks at the z depth by the following formula
$${b}_{bp}^{lidar} ( λ , z ) = 2 π χ {β}_{p}^{π} ( λ , z ) ,$$
where χ represents a conversion factor between
$${β}_{p}^{π} ( λ , z ) and {b}_{bp}^{lidar} ( λ , z ) ;$$
sub-step 1.4, based on the vertical profile of particulate backscattering coefficient along the lidar tracks
$${b}_{bp}^{lidar} ( λ , z )$$
and the vertical profile of photosynthetically available radiation along the lidar tracks PAR_{lidar}(z), calculating the vertical profile of chlorophyll concentration along the lidar tracks Chl_{lidar}(z), the vertical profile of phytoplankton carbon biomass along the lidar tracks
$${C}_{phy}^{lidar} ( z ) ,$$
and the vertical profile of phytoplankton growth rate along the lidar tracks μ_{lidar}(z) in turn;
sub-step 1.5, calculating the vertical profile of ocean primary productivity along the lidar tracks OPP_{lidar}(z) based on the vertical profile of phytoplankton carbon biomass
$${C}_{phy}^{lidar} ( z )$$
and the vertical profile of the phytoplankton growth rate μ_{lidar}(z), and accumulating the ocean primary productivity OPP_{lidar}(z) along the depth of z to obtain the total ocean primary productivity OPPₜₒₜₐₗ in the euphotic layer:
$${OPP}_{lidar} ( z ) = {C}_{phy}^{lidar} ( z ) \times {μ}_{lidar} ( z ) ,$$
$${OPP}_{total} = {\sum }_{0}^{z} {OPP}_{lidar} ( z ) ;$$
and based on the vertical profile of the particulate backscattering coefficient along the lidar tracks
$${b}_{bp}^{lidar} ( λ , z )$$
and the particulate organic carbon concentration data measured in the laboratory, establishing a linear fitting model to calculate the vertical profile of particulate organic carbon along the lidar tracks POC_{lidar}(z); accumulating POC_{lidar}(z) along the depth of z to obtain a particulate organic carbon stock
$${POC}_{stock}^{lidar}$$
in the euphotic layer; and calculating a particulate organic carbon output flux
$${POC}_{flux}^{lidar}$$
based on the particulate organic carbon stock
$${POC}_{stock}^{lidar}$$
in the euphotic layer:
$${POC}_{lidar} ( z ) = a 1 \times {b}_{bp}^{lidar} ( λ , z ) + a 2 ,$$
$${POC}_{stock}^{lidar} = {\sum }_{0}^{z} {POC}_{lidar} ( z ) ,$$
$${POC}_{flux}^{lidar} = b 1 \times {POC}_{stock}^{lidar} - b 2 ,$$
where a1 and a2 are both fitting coefficients of the water body particulate backscattering coefficient
$${b}_{bp}^{lidar} ( λ , z )$$
and the particulate organic carbon concentration; b1 and b2 are both fitting coefficients between the particulate organic carbon stock
$${POC}_{stock}^{lidar}$$
and the particulate organic carbon output flux
$${POC}_{flux}^{lidar} ;$$
and
sub-step 1.6, calculating the carbon sequestration efficiency of the oceanic biological pump E_{BCP} in the euphotic layer by the following formula:
$${E}_{BCP} = \frac{{POC}_{flux}^{lidar}}{{OPP}_{total}} .$$

5. The inversion method according to claim 3, wherein calculating the vertical profile of ocean environmental dynamic parameters along lidar tracks comprises the following sub-steps:
sub-step 2.1, carrying out gray processing on the water body Brillouin scattering interference circles acquired by the ICCD acquisition subsystem to obtain a gray image;
sub-step 2.2, processing the gray image by using an adaptive median filter to filter out salt and pepper noises in the gray image;
sub-step 2.3, carrying out a binary function processing on the gray image processed by the adaptive median filter to determine an optimal binarization threshold and obtain a binarized image; carrying out an edge processing on the binarized image to obtain an optimal edge function processed image; using an adaptive threshold processing function to obtain an optimal threshold parameter of an edge algorithm, and carrying out circle identification on the optimal edge function processed image to obtain a first-order elastic scattering circle radius
$${r}_{p}^{1} ,$$
a second-order Brillouin scattering circle radius
$${r}_{b}^{2}$$
and a second-order elastic scattering circle radius
$${r}_{p}^{2} ,$$
respectively; and using an identified concentric scattering circle radius and a free spectral range FSR of a Fabry-Perot interferometer to obtain a Brillouin scattering frequency shift Δv_{b}:
$$Δ {v}_{b} = \frac{{( {r}_{p}^{2} )}^{2} - {( {r}_{b}^{2} )}^{2}}{{( {r}_{p}^{1} )}^{2} - {( {r}_{p}^{2} )}^{2}} FSR ,$$
simulating, by a cylindrical lens beam transmission function, the gray image processed by the adaptive median filter to obtain a point-like spectrum intensity distribution image of different interference circles, and acquiring a Brillouin scattering linewidth Γ_{b}:
$${Γ}_{b} = \frac{{( {r}_{1} + {Γ}_{b}^{1} / 2 )}^{2} - {( {r}_{1} - {Γ}_{b}^{1} / 2 )}^{2}}{{( {r}_{1} + a )}^{2} - {r}_{1}^{2}} FSR ,$$
where r₁ represents a geometric radius of the center of the first spot of the point-like spectrum intensity distribution image,
$${Γ}_{b}^{1}$$
represents a full width at half maximum of the first spot in the point-like spectrum intensity distribution image, and a represents the distance between the center of a second spot and the center of the first spot; and
sub-step 2.4, repeating sub-step 2.1 to sub-step 2.3, calculating a Brillouin scattering frequency shift Δv_{b}(S, T, Z) and a linewidth Γ_{b}(S, T, Z) with a salinity of S and a seawater temperature of T at the z depth, establishing a functional relationship between the seawater temperature T, the salinity S and a depth of Z and the Brillouin scattering frequency shift and the linewidth, and obtaining the vertical profile distribution of ocean environmental dynamic parameters along the lidar tracks:
$$\{ \begin{matrix}Δ {v}_{b} ( S , T , Z ) = \pm \frac{2 n ( S , T , Z )}{λ} {V}_{s} ( S , T , Z ) \\ {Γ}_{b} ( S , T , Z ) = \frac{4 {π}^{2} Δ {{v}_{b} ( S , T , Z )}^{2} ( 3 {η}_{b} + 4 {η}_{s} )}{3 ρ ( S , T , Z ) {{V}_{s} ( S , T , Z )}^{2}}\end{matrix} ,$$
where n(S, T, Z) represents a seawater refractive index at the depth Z, with the salinity S and the seawater temperature T, Vₛ(S, T, Z) represents a seawater sound velocity at the depth Z, with the salinity S and the seawater temperature T, η_{b} represents a bulk viscosity coefficient, ηₛ represents a shear viscosity coefficient, and ρ(S,T,Z) represents a seawater density at the Z depth, with the salinity S and the seawater temperature T.
